(19) United States
(12) Patent Application Publication
(10) Pub. No.: US 2010/0274579 A1
(43) Pub. Date: Oct. 28, 2010

(54) Dynamic, Interactive, Web-Based Treatment System

(76) Inventors: Christian Marten, Wellesley, MA (US); Stephan T. Habermeyer, Brookline, MA (US)

Correspondence Address: Richard L. Sampson;SAMPSON & ASSOCIATES, P.C., 50 Congress Street, Boston, MA, 02109, US

(21) Appl. No.: 12/721,379

(22) Filed: Mar. 10, 2010

Related U.S. Application Data
(60) Provisional application No. 61/171,624, filed on Apr. 22, 2009.

(51) Int. Cl. G06Q 50/00; G06F 3/048; G06F 17/30

(52) U.S. Cl. 705/2; 715/769; 707/705; 715/764; 707/802; 707/E17.044

(57) ABSTRACT

A treatment system and method includes a treatment system server having a building block module to generate modular, interactive building blocks for treatment regimens. The building blocks represent a time-sensitive aspect of the treatment regimen, and are selectively assembled by a care provider client computer in substantially any combination, to form a customized treatment regimen. An assembly module transforms the building blocks into entries on a calendar viewable on a patient client computer. A transformation module transforms the patient input data into a display of patient progress. The treatment system server permits selective access to the treatment program by client computers. A webserver hosts a website to enable client computers to access the treatment system server. A treatment plan database server stores the assembled treatment plans. A communications server provides secure communications between care provider client computers and patient client computers, and between the webserver and a patient record database.

### RELATED APPLICATION

This application claims the benefit of U.S. Provisional Application Ser. No. 61/171,624, entitled Dynamic, Interactive, Web-Based Treatment System, filed on Apr. 22, 2009, the contents of which are incorporated herein by reference in their entirety for all purposes.

### BACKGROUND

1. Technical Field

This invention relates to systems and methods for the efficient delivery and monitoring of healthcare services, and more particularly, to an interactive treatment system operable in a client-server environment, for electronically generating and assigning treatment plans, monitoring patient compliance, capturing patient feedback and data, using patient feedback and data to possibly adjust treatment plans, and facilitating communication and electronic record keeping.

2. Background Information

Throughout this application, various publications, patents and published patent applications are referred to by an identifying citation. The disclosures of the publications, patents and published patent applications referenced in this application are hereby incorporated by reference into the present disclosure.

A wide variety of electronic monitoring and treatment systems exist for handling various aspects of the healthcare related issues. For example, an Internet-Enabled, Patient Monitoring System is disclosed in U.S. Patent Publication No. 2003/0036683 (the '683 reference). This reference recites methods and apparatus useful in translating a complex medical treatment plan of a medical outpatient into a sequential series of automated prompt and record events. This reference discloses linking databases with patients at remote locations to prompt them to comply with the steps of a medical treatment plan. The '683 reference teaches that its system operates by enabling a professional to progress through a series of windows in order to build and register an individual treatment regimen for each patient.

While this approach may offer various benefits, it is not without drawbacks. For example, the method in which the particular treatment regimen is generated is relatively inflexible, being constrained by the particular windows provided by the system. In addition, a new treatment plan must generally be created anew for each patient, with little ability for re-use with other patients or for sharing successful plans with other care providers. Moreover, the '683 plans tend not to be conveniently, automatically adjustable based on patient feedback.

U.S. Patent Publication No. 2008/0201174 discloses a Personalized Medical Adherence

Management System, which generates a health action calendar. This system may address the aforementioned drawback of plan adjustment, by receiving and interpreting patient responses and potentially modifying interventions based on those responses. However, like the approach of the '683 reference, this treatment plan is constrained by the inability to easily reuse or customize plans for other patients with similar conditions, or to share successful plans with other care providers.

Still further, it is noted that these conventional approaches are physician-centric, as they are used and managed by the care provider. As such, they tend to be exclusive to the particular care provider, thus lacking provision for monitoring or participation by others who may be involved in a particular patient's care.

Thus, a need exists for a web-based, interactive treatment system that overcomes the aforementioned drawbacks.

### SUMMARY

In one aspect of the present invention, a computer implemented interactive treatment system operable in a client-server environment, includes a treatment system server having computer readable program code disposed therein. The program code is configured to provide a building block module configured to generate a plurality of modular, interactive building blocks for a treatment regimen. The building blocks each represent a time-sensitive aspect of the treatment regimen, and are configured for being selectively assembled by a care provider client computer in substantially any combination, to form a customized treatment regimen. The program code is also configured to provide an assembly module to transform the building blocks into entries on a calendar viewable on a patient client computer. The program code also provides a transformation module configured to transform the patient data input via a patient client computer into a graphical display of patient progress. The treatment system server is configured for permitting selective access to the treatment program by care provider client computers and patient client computers. A webserver communicably coupled to the treatment system server hosts a website to enable patient client computers and care provider client computers to access the treatment system server. A treatment plan database server is configured to store the assembled treatment plans. A communications server communicably coupled to the webserver provides secure communications between care provider client computers and patient client computers, and between the webserver and a patient record database.

In a variation of the foregoing aspect, the program code is configured to provide the building blocks with a non-date specific temporal anchor point, so that the anchor points of the building blocks are linkable to one another upon assembly to form a non-date specific common anchor point of the treatment regimen. In addition, the building blocks are configured for being selectable for interactivity at the care provider client computer so that the blocks selectively request and capture responsive patient input. Further, the building blocks are configured to selectively escalate and de-escalate the treatment regimen based on the captured patient input. Also in this variation, the treatment system includes an override module configured to permit the care provider client computer to selectively escalate, de-escalate, and modify the treatment regimen. The communications server is configured to provide secure communications between the treatment system server and the care provider client computers, and between the treatment system server and the patient client computers.

In another aspect of the invention, a method of providing interactive patient treatment for a patient includes accessing the system described in the above aspect of the invention, using a care provider client computer, creating, with the system, a customized treatment regimen for a patient, wherein the regimen is accessible by the patient; and monitoring, with the system, the patient's treatment progress.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIGS. 1A-12 are screen captures of exemplary graphical user interface displays presented to care providers in an embodiment of the subject invention; and

FIGS. 13-22 are screen captures of exemplary graphical user interface displays presented to patients in the embodiment of FIGS. 1A-12.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Briefly described, embodiments of the present invention address the foregoing issues by providing a web-based, dynamic and interactive treatment (e.g., medical, rehabilitation, or training) system that provides a user friendly platform for professionals to develop and provide an interactive treatment regimen, while providing a convenient and secure means for (e.g., medical) record storage/access and communication between the professional, patient, and others selected by the patient. The platform includes a plurality of modular, interactive regimen building blocks (cards) configured for being selectively assembled in substantially any combination by the professional, e.g., by dragging and dropping visual representations thereof, to form a customized treatment regimen. (These modular building blocks may be provided by third parties and shared or purchased via download from the application's “market place” by the professional. The customized treatment regimen may be similarly shared or sold to other professionals and/or saved for reuse/modification at a later date.) The treatment plan then appears as a set of entries on a calendar viewable by the patient, whereas the customized treatment regimen is being aligned to an actual calendar by selecting an “anchor” or event date, e.g. surgery date, enrollment date or treatment start date. The modular blocks, or “cards”, are each selectable for interactivity by the professional, so that the blocks selectively request and capture responsive patient input. The individual modules may also be configured to escalate or de-escalate the entire treatment regimen based on the captured patient input. As such, the assembled cards may create a unique, individually tailored, interactive treatment regimen for substantially any sort of treatment, (e.g., for an episodic event such as a stroke, seizure, amputation, cancer treatment, neurological condition, etc.) or for substantially any other purpose for which a systematized treatment schedule may be desired, such as athletic training and the like. The cards thus provide a convenient means for building an initial treatment regimen, for modifying the regimen for reuse, and for disseminating/marketing successful regimens or sub-regimens to others. The system also includes a transformation module that transforms the patient input data into a graphical display of patient progress.

The system allows (health) professionals to create standardized treatment plans, which may be customized per patient. The process of care plan standardization and quick customization to individual patients alters and streamlines the care delivery, providing the best care plan for every patient while reducing costs in the health care delivery chain. Delivering the day-to-day activities via the patient's “View my plan” section, and allowing the patient to connect to the doctor anytime and anywhere is an integral part of the new care delivery model. This improves the patient's involvement/responsibility in their own treatment, which consequently may improve compliance, medical outcome and patient satisfaction.

The system serves as a secure medium by which professionals may observe the patient's compliance, monitor the patient's progress and communicate with the patient and other parties who may be involved in the patient's treatment. Permissions may be selectively applied to each party to selectively permit access to various data, which may include patient medical records stored in the system or accessible by link to a third party repository. Although the regimen may automatically escalate or de-escalate, the medical professional may override the system to make alterations in accordance with the information received from the patient.

The patient may be notified of the current daily plan (e.g., activities, e.g. exercises, medication, announcements, measurements, questions etc.) by logging on and viewing their calendar, or by an alarm. The technology may also be extended to be accessible on a smartphone or any other web-enabled device.

Besides the active involvement of patients in their care program, other benefits of this approach include improved communication and work-flow efficiencies (e.g. no cluttered paperwork, less unnecessary phone calls, electronic referral and appointment system, integration with EMR (Electronic Medical Records) and PHR (Patient Health Records) systems). The system provides an interactive treatment application that a patient may access from substantially anywhere internet access, even via cell phone networks, is available. The system may also provide the medical professional with detailed real-time information about a patient's compliance with the treatment program and progress, and consequently allows a doctor to quickly and accurately determine necessary alterations to the treatment regimen.

As used in this document, the term “computer” is meant to encompass a workstation, personal computer, personal digital assistant (PDA), wireless telephone, or any other suitable computing device including a processor, a computer readable medium such as a disk drive, flash drive, or other media, upon which computer readable program code (including instructions and/or data) may be disposed, and a user interface. The term “embedded computer” is meant to encompass a computer as defined above, configured for a dedicated use, and which lacks a conventional user interface such as a display and keyboard typically associated with workstations, personal computers, etc. Terms such as “module”, and the like are intended to refer to a computer-related entity, either hardware including computer readable media such as hard drives, disc drives, flash drives, etc., a combination of hardware and software, software, or software in execution. For example, a module may be, but is not limited to being, a process running on a processor, a processor, an object, an executable, a thread of execution, a program, and a computer. By way of illustration, both an application running on a server and the server can be modules. One or more modules may reside within a process and/or thread of execution and a module may be localized on one computer and/or distributed between two or more computers or control devices. The term ‘real time’ refers to sensing and responding to external events nearly simultaneously (e.g., within seconds, minutes or hours) with their occurrence, or sufficiently fast to enable the device to keep up with an external process (for example, sufficiently fast as to avoid losing data generated by the receiving modules).

Aspects of systems and methods embodying the present invention may be programmed in any suitable language and technology, such as, Hypertext Markup Language (HTML), Active ServerPages (ASP) and Javascript. Alternative versions maybe developed using other programming languages including, but not limited to: C++; Visual Basic; Java; VBScript; Jscript; BCMAscript; DHTM1; XML and CGI. Any suitable database technology can be employed, but not limited to: Microsoft Access and IBM AS 400.

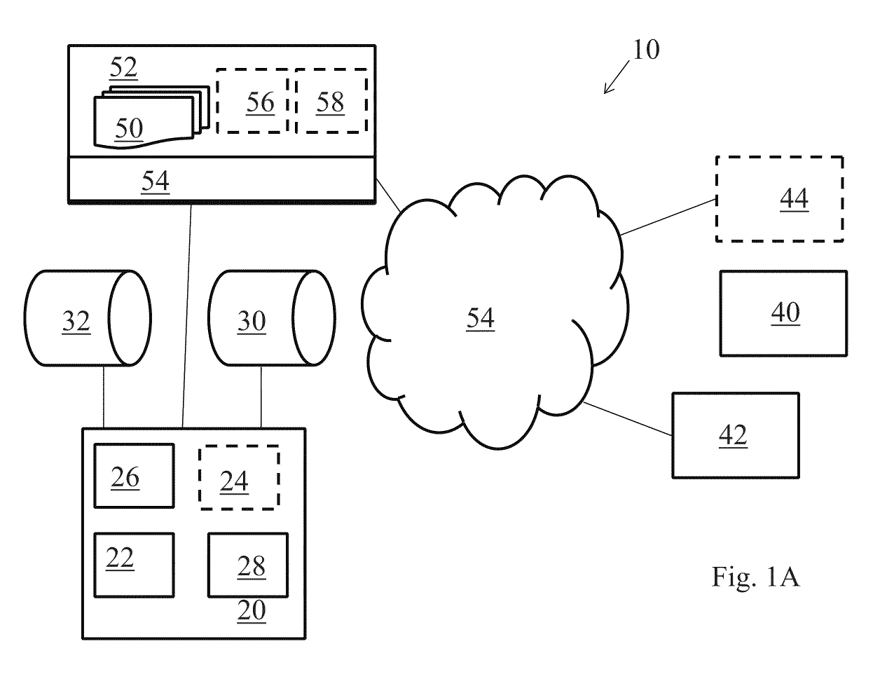

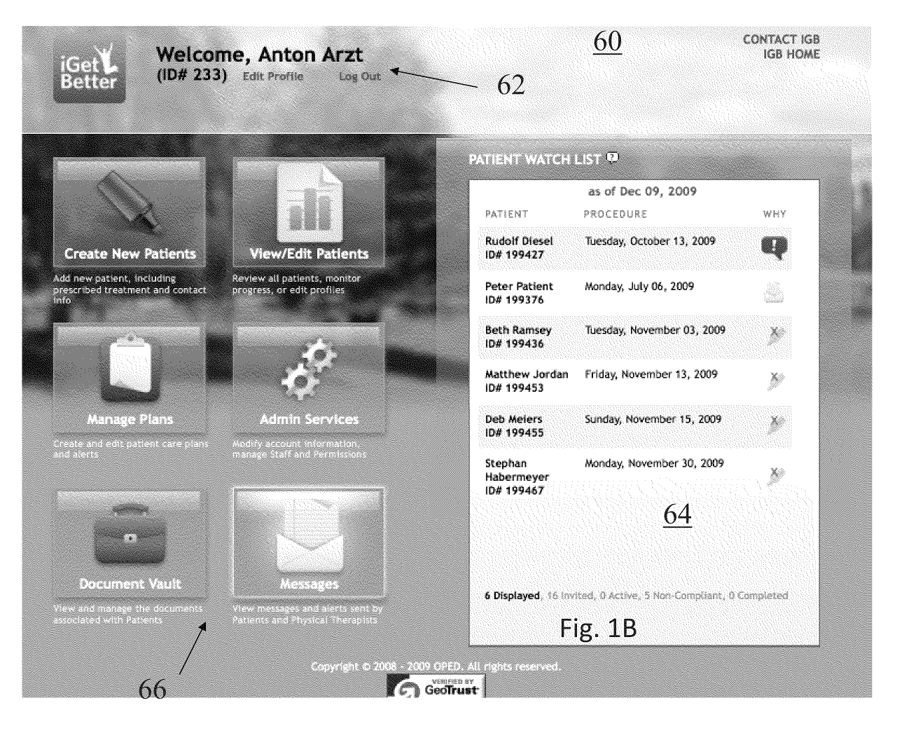

Referring now to the Figures, embodiments of the present invention will be more thoroughly described. Turning now to FIG. 1A, in one embodiment of the invention, an interactive treatment system 10 includes a treatment system server 20 having computer readable program code configured to provide a building block module 22, an assembly module 26, and a transformation module 28. Server 20 is communicably coupled to a webserver 52 configured to host a website 50, which enables users to access server 20 via care provider and patient client computers 40, 42, respectively.

In particular embodiments, building block module 22 is configured, e.g., with computer readable program code, to generate a plurality of modular, interactive building blocks for a treatment regimen. As will be discussed in greater detail hereinbelow, the building blocks each represent a time-sensitive aspect of the treatment regimen. Examples of these time-sensitive aspects may include periodic events such as exercises that may be assigned on a daily or weekly basis, and one-time aspects such as a reminder to be fitted for a boot or other rehabilitation device. The building blocks are configured for being selectively assembled by a care provider client computer 40 in substantially any combination, to form a customized treatment regimen.

System server 20 also includes an assembly module 26 configured to transform the building blocks into a treatment program which may be displayed as entries on a calendar viewable on patient client computer 42. Examples of these calendar entries include daily activities such as exercises, medication reminders, general reminders, and requests for feedback, etc.

The transformation module 28 is configured to transform the patient data input via patient client computer 42 into a graphical display of patient progress. In particular embodiments, this module 28 is configured to accomplish this transformation substantially in real-time, i.e., as the patient provides the responsive input. This transformation will be described in greater detail hereinbelow.

A treatment plan database server 30 communicably coupled to plan server 20 is configured to store the assembled treatment plans.

A communications server 54 communicably coupled to webserver 52 is configured to permit selective access to the treatment program (e.g., server 20) by care provider client computers and patient client computers 40, 42. Communications server 54 is also optionally configured to provide client computers 40, 42, with secure, selective access to a patient records database 32, e.g., via server 20 as shown.

As discussed in greater detail hereinbelow, particular embodiments of the present invention may be optionally configured to provide each of the building blocks with a non-date specific temporal anchor point. These anchor points may be configured so that once the building blocks are assembled into a treatment plan, the anchor points may be linked to one another to form a non-date specific common anchor point of the treatment regimen.

This common anchor point may then be mapped to a particular calendar date, such as a surgery date, an injury date, a treatment enrollment day, a training commencement date, etc.

Moreover, building block module 22 may be configured to provide the building blocks with the ability to selectively escalate and de-escalate the treatment regimen based on captured patient input, e.g., from building blocks configured for interactivity as discussed above. As also shown, an optional override module 24 may be configured to permit the care provider client computer 40 to selectively escalate, de-escalate, and modify the treatment regimen.

It should be recognized that the care provider client 40 and patient client 42 may include substantially any device capable of accessing network (e.g., Internet) 54, including conventional general purpose computers, cell phones, PDAs, or substantially any other web-enabled device. Patient data may be entered manually by the patient, or devices can be used that upload data (e.g. certain measurements such as blood glucose levels, ECG, body weight) automatically by connecting via a suitable network, e.g., Internet, cell phone network, etc.

In still further embodiments, the webserver 52 may be provided with a publication module 56 configured to access system 20 and treatment database 30 to make the entire assembled plans or portions thereof, such as individual building blocks, selectively available to multiple care provider client computers 40. Publication module 56 (the “marketplace”) may thus be used to share treatment plans and/or specific building blocks, with other care providers. These shared plans/blocks may then be used by other care providers, using system 20, with their own patients. Indeed, the modularity of the individual building blocks, as discussed above, permit the building blocks to be easily downloaded via publication module 56/webserver 52 and incorporated into other treatment plans. In particular embodiments, module 56/webserver 52 may facilitate the sale of treatment plans/blocks, e.g., in the manner commonly used by Apple iTunes® and other online stores for the purchase of downloadable music and the like.

These embodiments may thus provide a user friendly platform for professionals to develop and provide an interactive treatment regimen, while providing a convenient and secure means for record storage/access and communication between the professional, patient, and others selected by the patient, as will be discussed in greater detail hereinbelow.

As also shown, an optional referral/appointment server 58 having computer readable program code thereon, may be provided for communicating referrals from a referring care provider client 40 to another care provider client, via the webserver 52. Similarly, server 58 may be configured to communicate appointments between care provider clients 40 and patient client computers 42, and to optionally transmit claims from these clients to an insurance company or other payor, which may log onto the system via a payor client computer 44.

Referring now to FIGS. 1B-22, exemplary embodiment of the present invention, including methods of operation thereof, will be more thoroughly described.

Turning to FIG. 1B, a physician or other care provider logging into system 10 via client 40 (FIG. 1A) would initially be presented with a home screen 60. In the embodiment shown, screen 60 may greet the physician by name and ID number 62, and may provide a patient watch list 64 where alerts and messages from patients and possibly the administration and colleagues appear. In the embodiment shown, the Patient Watch List 64 includes alerts and messages from patients. Another similar Message List (not shown) may be provided for messages from non-patients (e.g., colleagues, etc.).

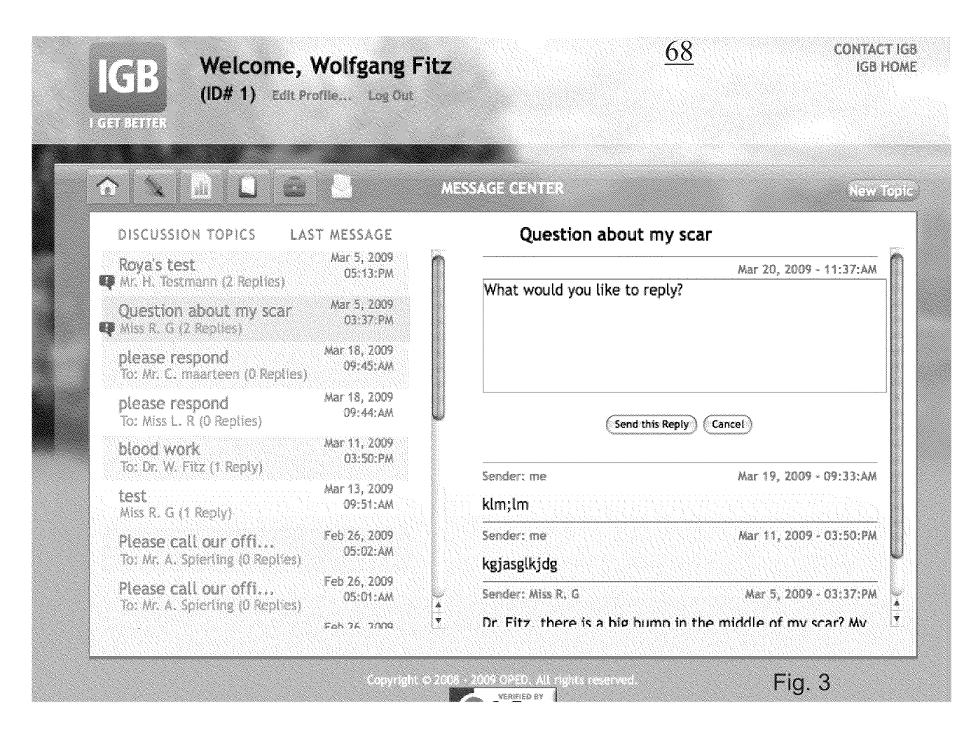

Alerts may be highlighted e.g., with color, such as shown on the Message Center screens of FIGS. 3 & 4, which will be discussed in greater detail below. Embodiments of the system may include logic that places alerts on the top of the list while simple messages from patients or reminders generated by the system that certain patients are non-compliant, e.g., for not entering requested information, are posted below the alerts, representing lower priority.

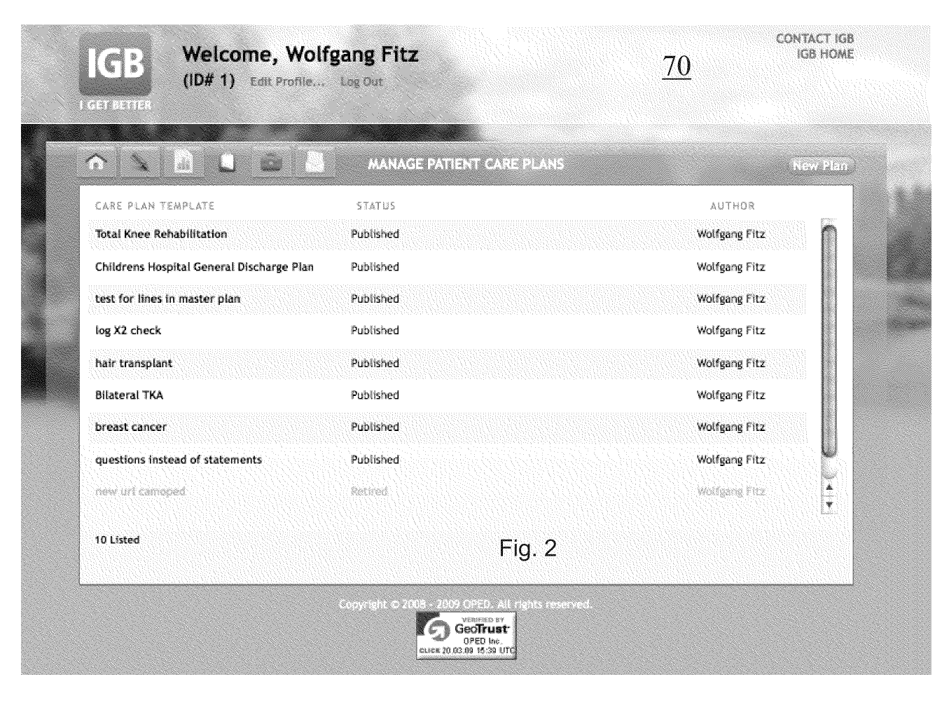

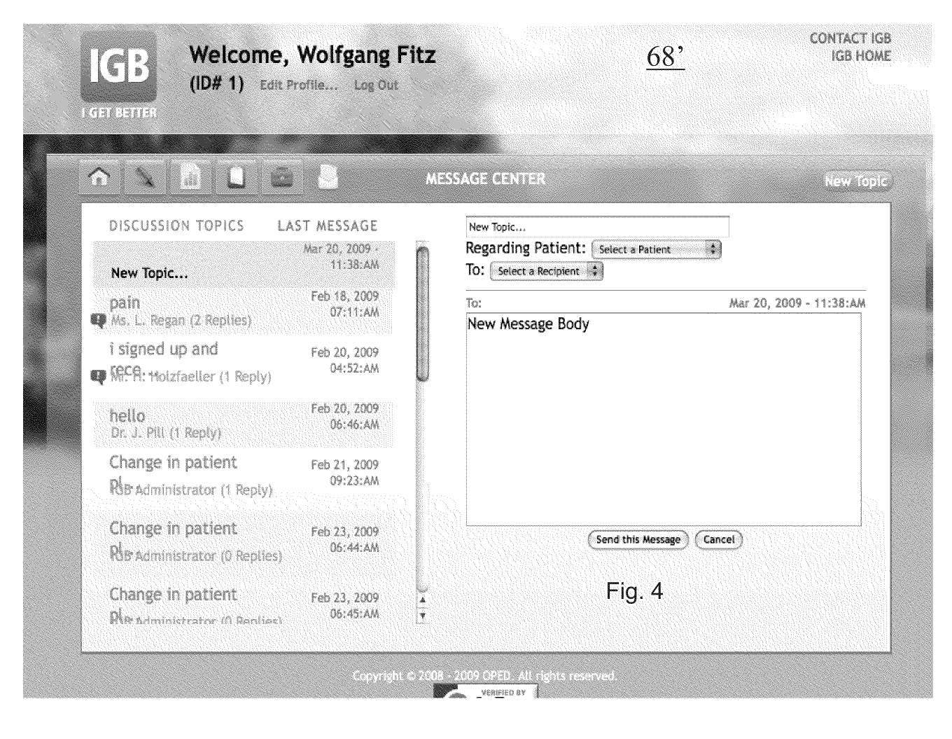

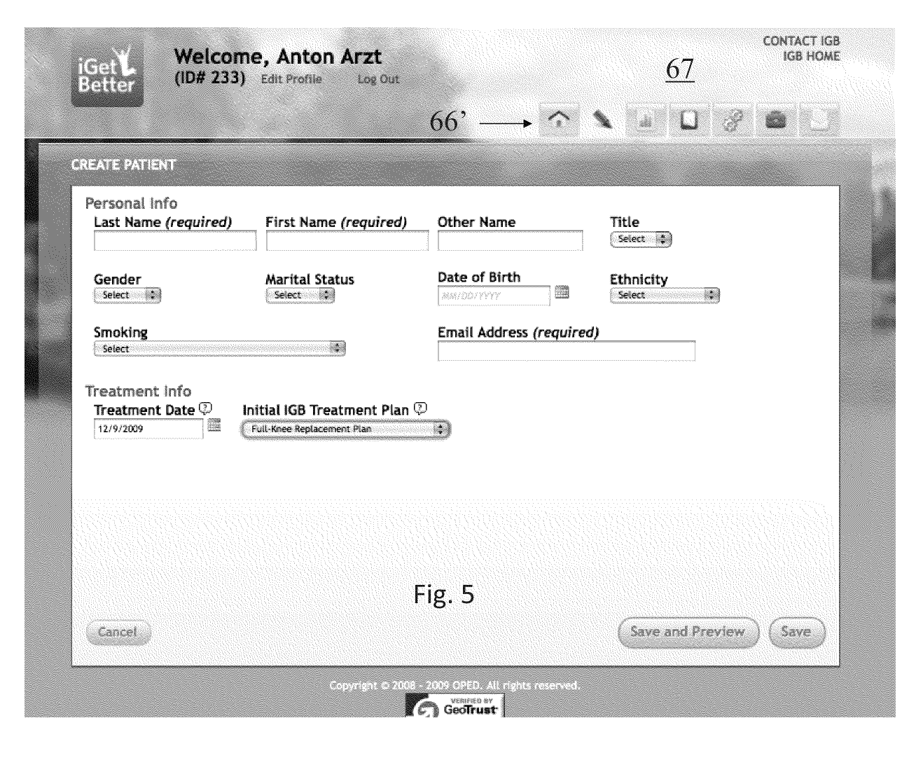

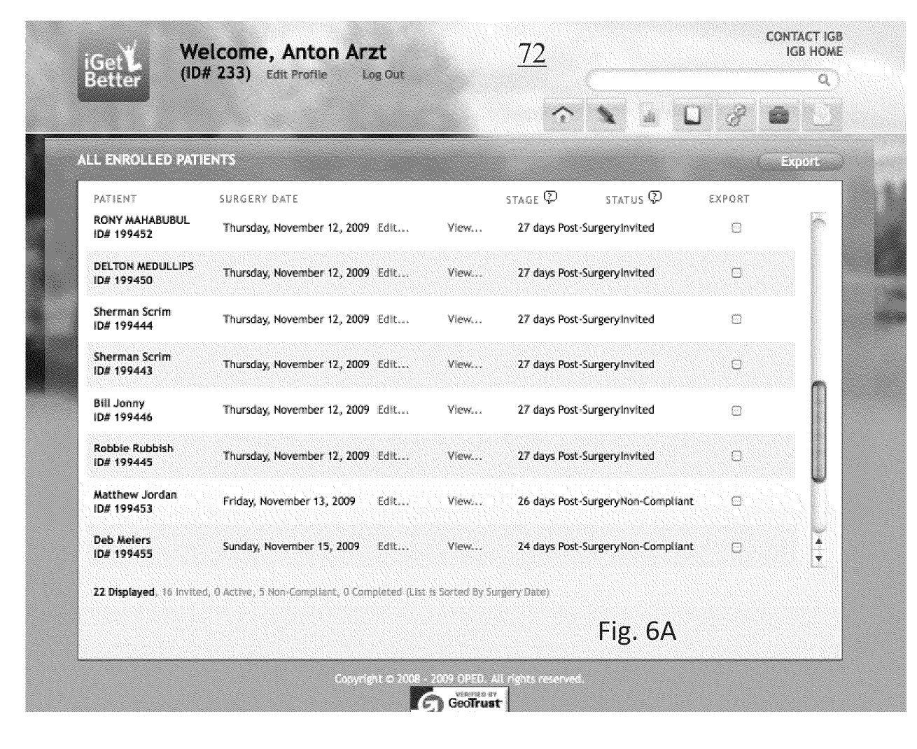

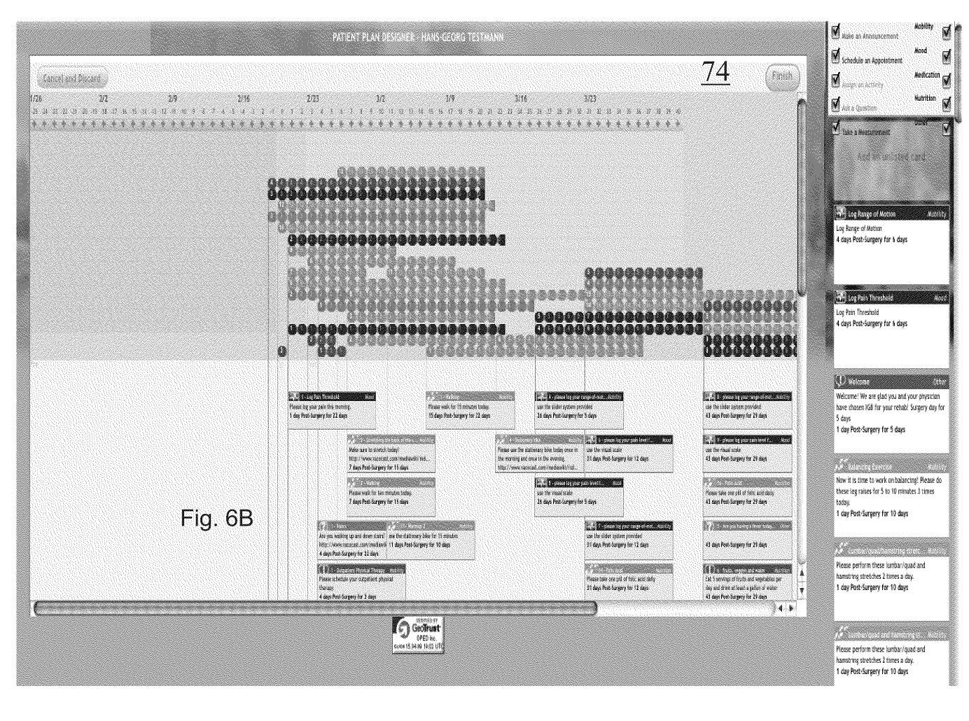

As also shown, screen 60 may include an array of various icons (e.g., shortcuts) 66 providing the physician with various system functions. Icons 66 may be provided for signing up a new patient, e.g., via Create Patient screen 67 (FIG. 5), viewing or editing patients via Enrolled Patients screen 69 (FIG. 6A), and creating and/or modifying treatment plans via Manage Patient Care Plans screen 70 (FIG. 2). The icon Admin Services may be used to manage practice/facility staff members and their respective permissions concerning the use of the application. Another icon entitled Document Vault may be used to access patient files, such as may be stored on servers 30 or 32 (FIG. 1A). Still another icon provides access to the message center screens 68, 68′ (FIGS. 3, 4), e.g., as effected by communications server 54 (FIG. 1A). It should be noted that as used herein, the term ‘physician’ and/or ‘doctor’ is used for convenience to refer to substantially any individual or group that may be involved in the care of a patient or client, including physicians of substantially any specialties, physical therapists, nurses, chiropractors, personal trainers, coaches, etc., i.e., anyone who may wish, and is authorized, to provide and manage plans for one or more patients or clients. Similarly, the term ‘patient’ is used for convenience to refer to substantially anyone for whom the aforementioned plan is provided.

Turning now to FIG. 5, a user may create a new patient by accessing screen 67 and entering the patient's demographics and e-mail address, and then setting the treatment (anchor) date, such as a surgery date. As discussed hereinabove, it is noted that plans created with embodiments of the present invention are tied to an event, i.e., day zero or the ‘anchor point’, which in the example shown, is the surgery date. However, the anchor date may also be the date of a medication treatment or an office visit. Any particular event or day may be the anchor point, which then allows any type of patient or client to be given a plan at substantially any time during a real calendar year or calendar date, by tying it to the anchor date.

In the example shown, the physician is creating a plan for orthopedic intervention/rehabilitation, so the anchor date is the surgery date because this is when the patient is in the hospital and having surgery performed. This anchor date is also used because the physician knows what kind of procedure he or she is planning and a treatment plan may be assigned that has been predetermined, or standardized, for rehabilitating patients that have undergone this particular procedure. In the example shown, a standardized plan called “full-knee replacement plan” is selected, which means the physician is initially assigning a standardized rehabilitation program which may be generally suitable for any kind of patient that undergoes total knee rehabilitation.

The physician may modify and customize this general plan for each patient's particular situation. For instance, if the patient has any allergies which preclude certain medications, then the medication may be changed. If more or less aggressive therapy is desired, or if there are certain exercises a patient cannot perform because of pre-existing conditions, etc., these may be modified. The manner in which such modifications may be effected will be discussed in greater detail hereinbelow.

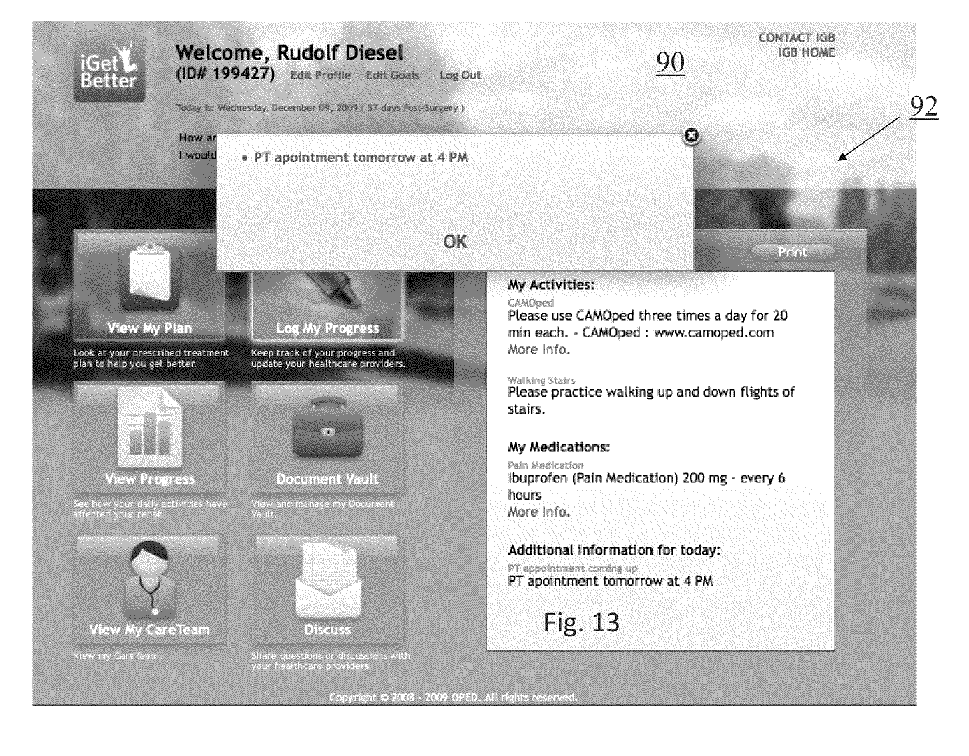

The physician may then either save and preview the plan, whereas the plan is shown, or the plan may simply be saved (e.g., to database server 30, FIG. 1A), which serves to assign this plan, the date, etc., to this particular patient, and the system may then send out an e-mail invitation to this particular patient. The patient then receives the e-mail saying that he or she has been invited by the physician, and which provides a link which the patient may follow to enter the system, and accept or reject applicable terms and conditions. Once accepted, the patient will be able to set himself or herself up in the system and be ready to use it. (Use of the system from the patient's perspective will be discussed in greater detail hereinbelow, with respect to FIGS. 13-22.)

At this point, the system will have transferred the selected standardized plan(s) to the patient, and synchronized it with the specified anchor date. The system 10 then detects where this particular patient is in regards to his or her anchor date. For example, the system determines the actual current date relative to the surgery date and adjusts the plan accordingly. So, if the current date is March 10, but the surgery date is set for a week later on March 17, then the system will not show anything on the patient's plan until after March 17, unless pre-surgical (or pre-anchor date) activities are part of the care plan.

In this regard, it should be noted that the plan is based on the anchor date, not the date that the patient actually begins the plan. For example, if the plan was assigned the day after the surgery date (using the surgery date as the anchor date), but the patient doesn't sign on until a week later, the patient may start complying on day 8, with the activities assigned for day 8. (For accuracy of record keeping, embodiments of the system will not permit prior days' entries to be altered.) Similarly, in the event the surgery is on Monday, but the doctor doesn't have time to assign a plan until Friday, the anchor date will remain the actual surgery date, not the date the plan was assigned. So in general, the plan will not change based on when the patient actually begins to comply. For example, identical plans for two patients with the same surgery dates, and who provide the same feedback to the system, would remain synchronized with one another even if the patients began complying with their plans on different days. The system does, however, permit the physician to adjust the plan if necessary, such as to adjust for the speed at which the particular patient is recovering. Moreover, as discussed in greater detail below, the plan may automatically adjust based on feedback provided by the patient, e.g., to accelerate or decelerate based on patient status.

The physician may then select a short cut icon from icon array 66′, such as displayed along the top of the various screens, or may go to the home screen 60 (FIG. 1B) and select an icon there, for an Enrolled Patient List 72. Turning now to FIG. 6A, Enrolled Patient List 72 lists all the patients that a physician has enrolled into the system 10. In the particular embodiment shown, it provides a brief overview, e.g., indicating that there are 22 patients, 16 of which have an invited status, which means they have been invited but have not yet accepted the invitation and are not yet completely enrolled and thus cannot participate. The overview may also show how many are active, how many are non-compliant, and how many have been through their entire plans and are thus completed. As used herein the term ‘completed’ means they have reached the last day of their plan.

In this screen 72, the physician may edit the patient's information, and/or see what kinds of plans the patient had been assigned to, such as by double-clicking the ‘Edit’ or ‘View’ buttons associated with the patient's name. For example, clicking on the “Edit” button may reveal that a patient has only the initial plan assigned by the doctor, such as the total knee rehabilitation plan discussed above. This screen may thus also show whether a secondary plan, such as generated by the same or another health care provider, has been assigned to the patient. For instance, a physician may provide a plan that only contains medication and may leave the exercise and physical therapy portion to a physical therapist who may, once invited as part of the health care team for a particular patient (discussed below), assign a physical therapy plan to the patient.

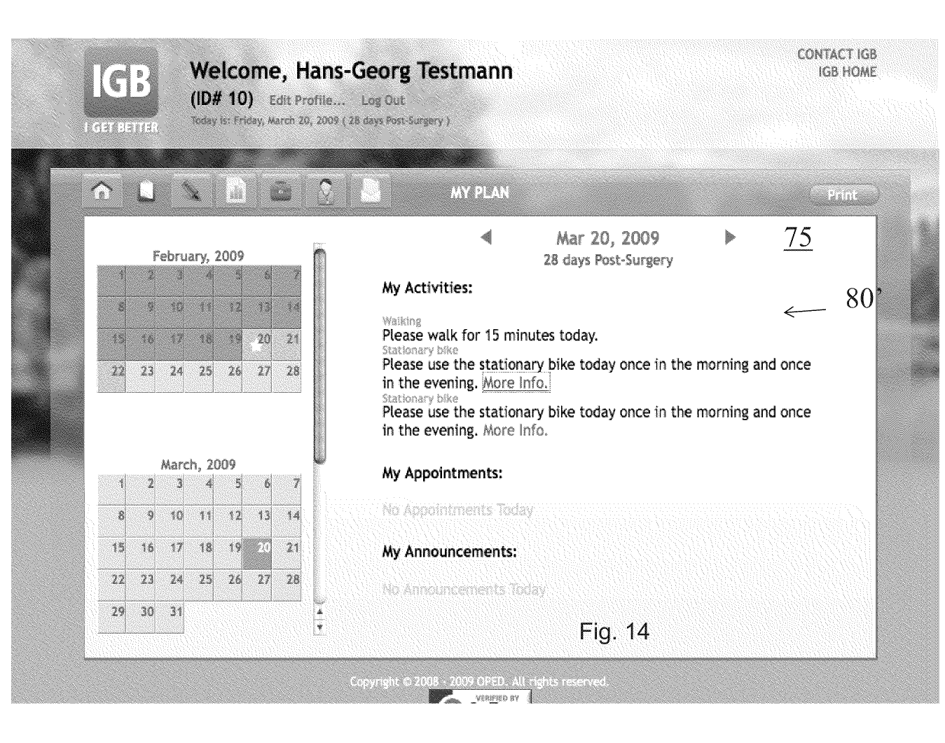

The “Edit” button may thus provide the healthcare provider with a particular patient's consolidated plan 74, as shown in FIG. 6B, which is a summary of all activities coming from as many plans as have been assigned to the patient. From this screen 74, the provider may drill down to see the detail of what is expected of the patient on a day to day basis, e.g., by clicking on a particular day at the top of the screen, to display a calendar screen similar to calendar screen 75 of FIG. 14, as will be discussed hereinbelow. On screen 74, the anchor date is shown at zero, which in this case is the surgery date, along with the various activities that have been prescribed in relation to surgery.

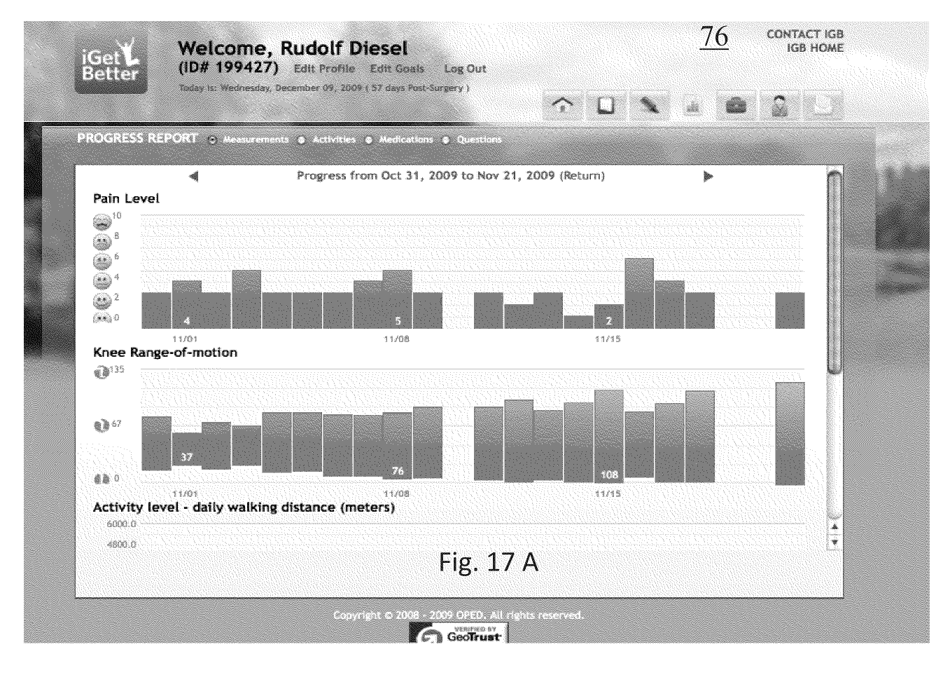

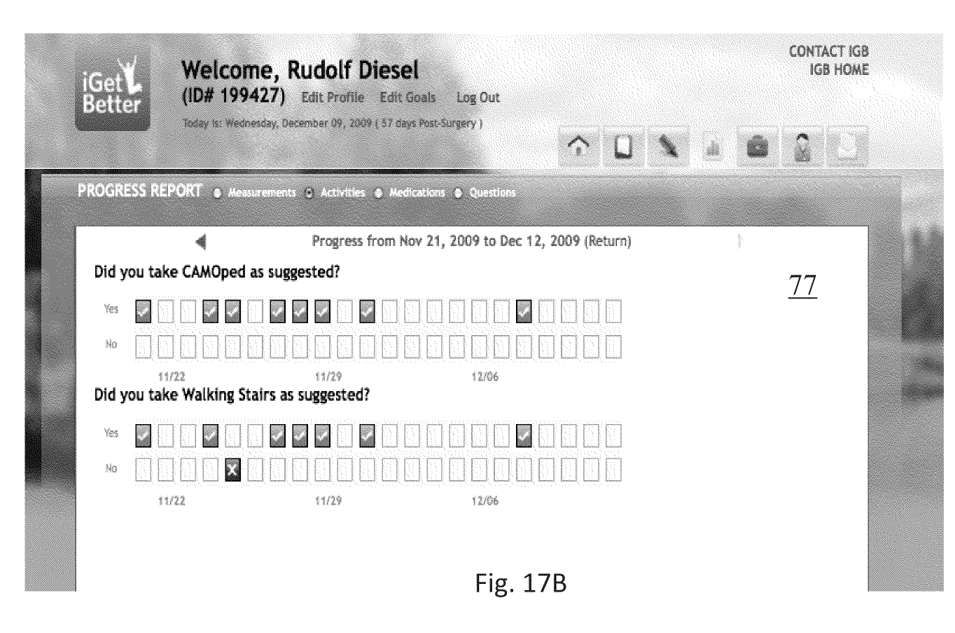

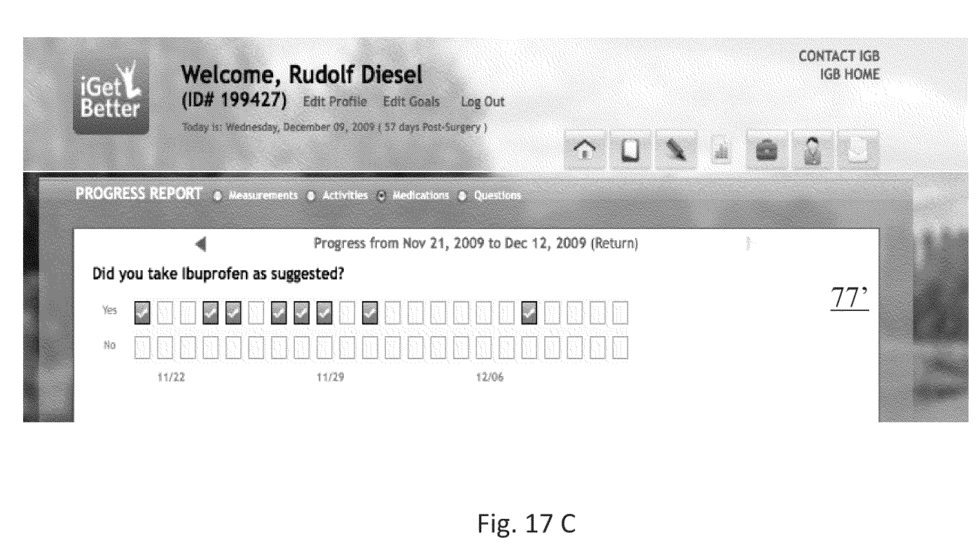

By actuating the “View” button of FIG. 6A, the care provider may view a progress report 76 for a particular patient, such as in the form of a graphical display (e.g., generated by transformation module 28, FIG. 1A) shown in FIG. 17. As one can see in FIG. 17, this patient logged his range of motion fairly consistently and on March 1 had a certain amount of range of motion in the knee which was substantially reduced on March 2. This screen also shows how the patient's pain level has changed over time.

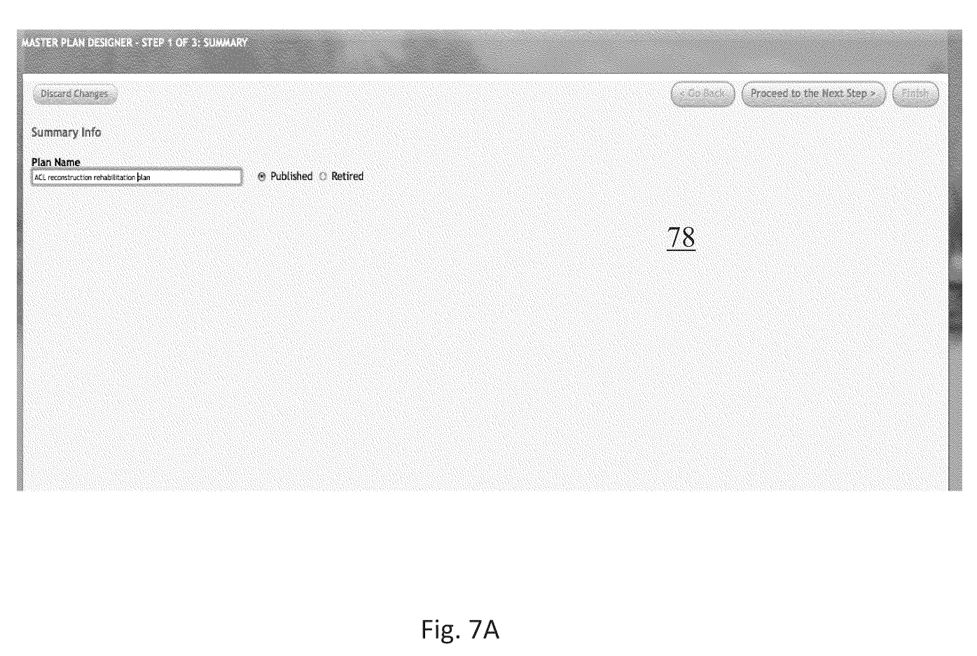

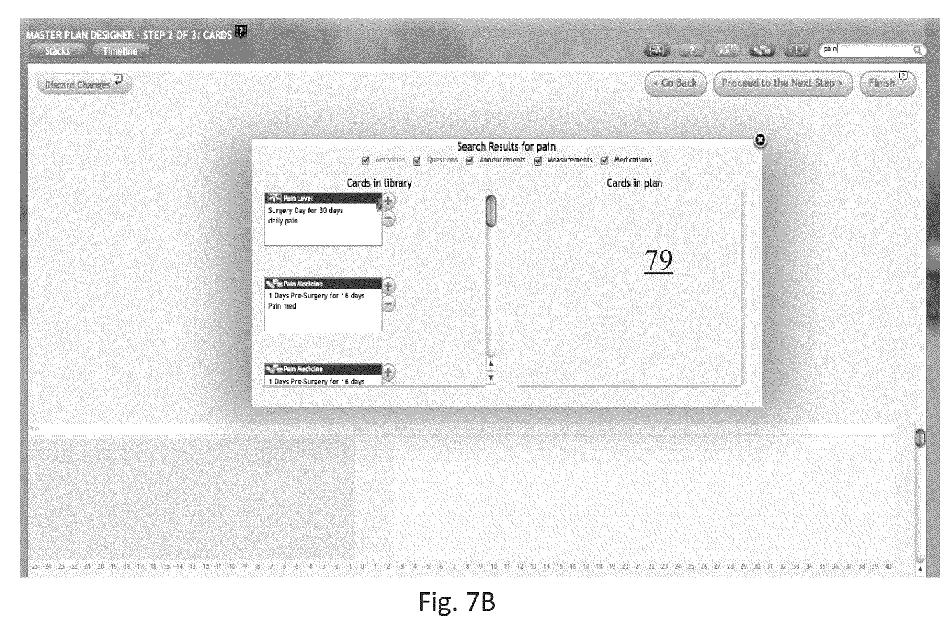

Turning now to FIGS. 7A to 11, a physician or other health care provider may create a plan by opening the Master Plan Designer 78 (FIG. 7A), e.g., via the Manage Plans shortcut on the home page. In the example shown, the physician is creating a new care plan called “ACL reconstruction rehabilitation plan”. After selecting the “Proceed to the Next Step” button, the physician is now able to create a care plan. As shown, in FIG. 7B, the physician may either search the library of previously created/used cards using search window 79 (showing, e.g., library entries for the search word “pain”), or create new cards. The bottom of the screen of FIG. 7B shows the anchor date at zero. In the top section of the search pane 79 is a filtering tool which enables the user to filter for announcements, appointments, activities, etc. So, for example, if a physician has a knee surgery planned for a patient, and already has a plan for hip replacement, although the plans would be different, there may be aspects of the existing plan that may be applicable to the new plan. For example, an existing plan may have had a measurement keyed to begin five days before the surgery date, and ending ten days after the surgery date, asking the patient to report her/his pain level, e.g., on a pain scale of 1 to 10.

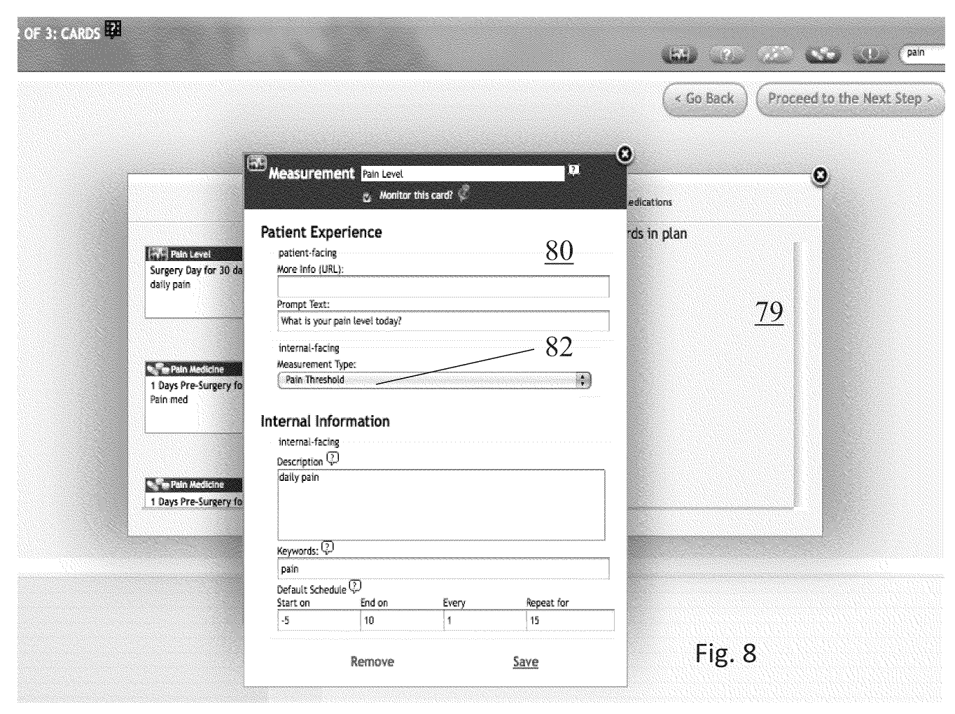

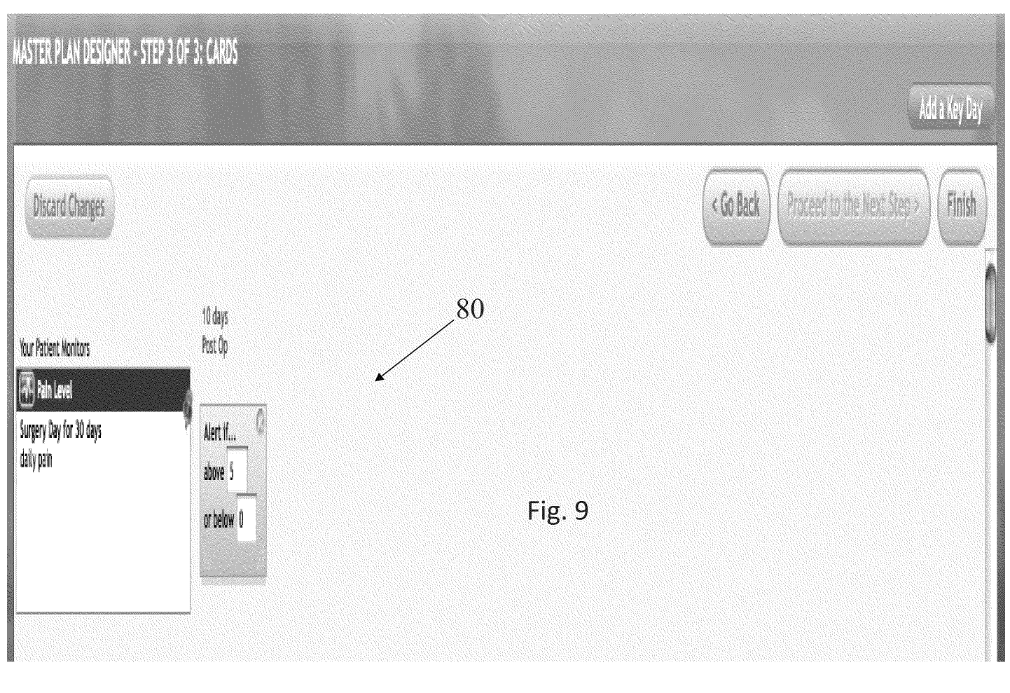

Once a desired card/building block 80 has been located, it may be selected for usage in the new plan as shown in FIG. 8, and edited for the particular patient, e.g., by clicking on a card 80 in the plan 82 shown in the screen of FIG. 8, and/or in the screens of FIGS. 9, 10 and 11. In this regard, it is noted that when a health care provider puts this card in his library to be used later for other patients, there is no date on that card. If there were a date, each time that card was used for another patient, he would need to open it and change the date. However, the present invention eliminates the need for such steps, by use of the aforementioned anchor date. When the card is added to the plan (e.g., by dragging and dropping), the minus and/or plus information in the schedule fields of the card are automatically keyed to the anchor date inputted earlier for the particular patient. So the card knows for that particular patient when this activity is going to happen and the message to the patient happens on that date even though the doctor doesn't mention any date. So this is a convenient approach for both creating a library of useful plan elements, and enabling them to be conveniently re-used without requiring dates to be reentered for each and every patient.

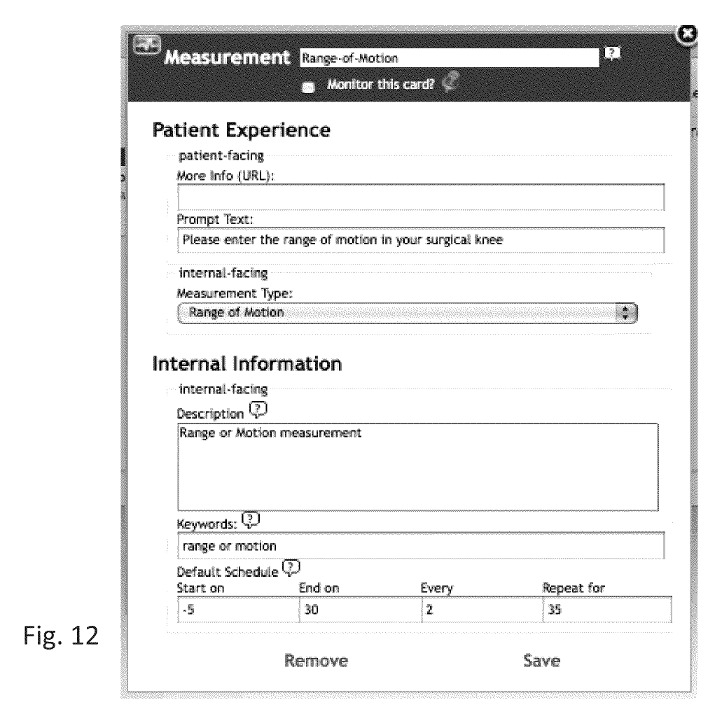

A typical card 80 may be configured for at least six distinct purposes/types, e.g., medication, activity, question, measurement, announcement, and appointment. The desired type may be selected using type field 82, which as shown, may include a selectable pull down menu listing the various types. It is also noted that each card 80 is selectively interactive, e.g., to require feedback from the patient. For instance, measurement cards may be configured to request responses from the patient (entered manually by the patient; e.g. pain level, body weight, fluid intake, distance walked) or may enable the system to receive data provided by ambient devices automatically (e.g. plantar foot pressure profile, stepcount, blood glucose level). For example, the card 80 of FIG. 8A may ask the patient for a response regarding present pain levels. Another card may ask the patient to record range of motion, e.g., of a knee after the surgery, as shown in FIG. 12. As yet another example, an appointment card may be used to remind the patient to schedule an appointment with a physical therapist 8 days after the surgery date. Such an appointment card may enable the physician to set various applicable parameters, such as the type of appointment (e.g., physical therapy), the number of sessions, location, and to request a response from the patient confirming that the appointment has been made and adding it to the plan and/or library. When added to a plan, the cards may also automatically generate an email forwarding a calendar event file to the provider (e.g., physical therapist), which may then be accepted, placing it into the users' in-network calendars, such as shown at screen 75 of FIG. 14.

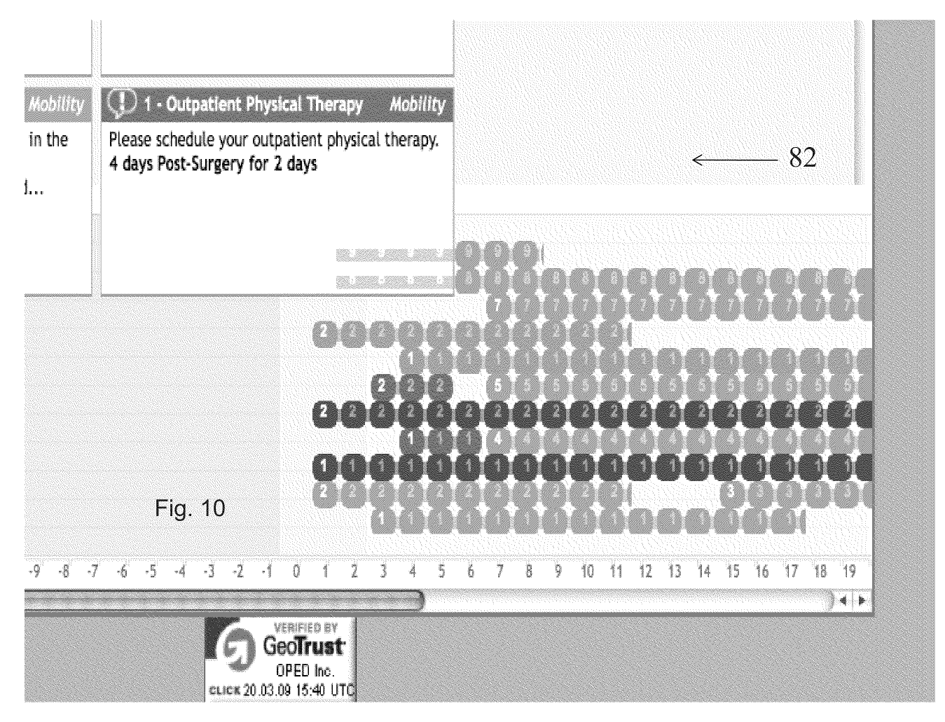

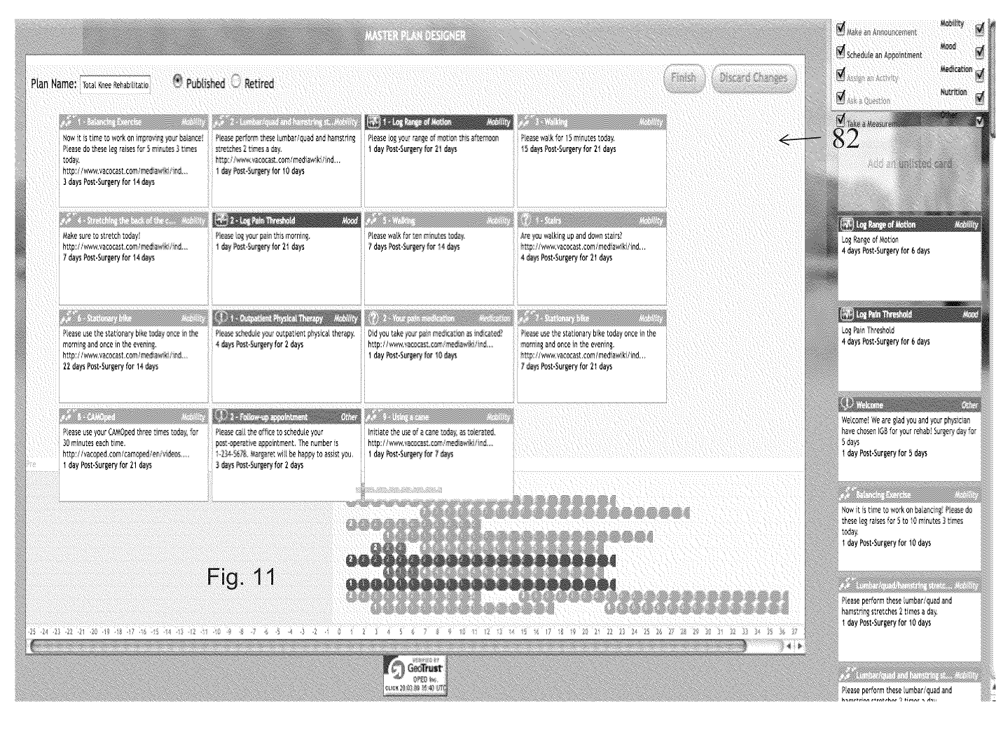

Once the card 80 has been properly configured, the user may select the “Proceed to the Next Step” button to add the card to the plan, as shown in FIG. 9. The foregoing steps may be repeated, e.g., by selecting the “Go Back” button until the screen of FIG. 7A is reached, to add other cards 80. The user may then select the “Finish” button once the plan is complete, to display the completed plan shown at FIGS. 10 and 11.

The cards/blocks 80 may also include a field (not shown) for entering additional information, such as a description or a URL for a web page that may be useful to the patient. For example, a link may be provided to one or more references providing information on prescribed medications. A patient may thus click on the link (e.g., from calendar screen 75, FIG. 14) to obtain this information.

Other examples of additional information that may be provided via the More Information field include information related to a list of various activities from which a healthcare provider may typically select. For instance, a card 80 may be created instructing the patient to use a stationary bike three times a day. The More Information field may be preconfigured to include, for instance, the maker of the bike and the instructions for use, such as how to adjust the seat height properly and the handles, etc. The card enables the provider to select whether a response is required from the patient, as discussed above, and if so, what the response should look like. If particular equipment is needed, it may be selected, e.g., from one or more preselected vendors. The provider may also choose to generate an order or prescription for the device electronically, e.g., for crutches or for a walking boot.

In this regard, it should be noted that icon array 66, 66′ (FIGS. 1A, 5) may be provided with an icon configured to permit a physician to look up available medications, generate a prescription, and electronically transmit the prescription to the patient's preferred pharmacy, e.g., using referral server 58 (FIG. 1A). Alternatively, the prescription may be transmitted electronically, e.g., using communications server 54, to the patient who may then print it out in paper form and then bring it to the pharmacy.

Referring back to FIG. 1B, icon array 66 may include a shortcut configured for access to a document vault, such as database 32 (FIG. 1A). Here, a user may see if a patient has any kind of information, e.g., an x-ray, MRI, lab report or office notes, etc., uploaded to the system. The physician, having been granted permission by the patient, may then open and view the documents. Anybody that is part of the health care team for a patient may add other documents, so the user may simply hit the add button and browse a hard drive or intranet and just select the file added to the patient. Moreover, patient information may be up- or downloadable to or from third party PHR (Patient Health Record) systems, such as Google® Health™ or Microsoft® HealthVault™.

Additionally, embodiments of the system may offer a message board/alert/task functionality accessed by a Message icon 66/communications server 54, in which one may exchange information or otherwise easily communicate with everybody that is tied to a particular patient. It should be noted that in particular embodiments, anyone that is part of the health care team for a particular patient will have the right to upload relevant patient information. However, because the system 10 is patient centric, nominally the only person with permission to delete anything would be the patient. Similarly, the patient is also the person who may determine what can be seen by whom. So for example, the patient may permit a lab result to be viewed by the physician, but not by the physical therapist.

Cards can also be selected for automatic monitoring (e.g. yes/no responses, defined thresholds via numerical values or ranges). For instance, a physician may need to know that on day 10 after surgery a patient has a pain level of or greater than five (FIG. 8C). Consequently, the system monitors all pain entries by patients on day 10 after surgery. Should a patient report level 5 or greater, the system then automatically issues a notification email to the designated addressee (physician or staff member), stating that a threshold violation has occurred. The addressee can then find details after entering the secure application.

Still another optional method of communication is by generation of a “case” or “task” card 80. This card may be generated as described above, but which is effectively a blank card that will not be associated with any particular patient plan. A healthcare provider may initiate this card and circulate it among the various entities or individuals who are participating in the care of this patient. For example, this extra-plan card may be sent to a laboratory doing blood work or to an x-ray facility, etc., to make a request or ask a question that may need be addressed, and thus circulate to others in the network. So when a doctor opens a new blank “case” card, it will be a card 80 attached to the patient but which may circulate until it is closed and the issue addressed. And each time it reaches a destination, the recipient, such as a lab which may have been tasked with running particular blood tests, may indicate whether the task has been completed or whether it is waiting in someone's queue. Once the task(s) have been indicated as having been completed, the card is closed, and may be stored in the patient's history. This “case” card thus effectively serves as a borderless tracking system, for tracking the completion of events or inquiries, etc. Essentially this card may be viewed as a floating task or to-do list item, which may be generated by one person and sent to another party, where it will appear on their screen as a To-Do item until completed. And when the person completes the task, the person may either reply to the initiator of it and say it's all done or they may redirect it to somebody else who is the next in line to work the task, e.g., because the first party only addressed a part of it. This “case” card may also be used to transfer existing documents or files. For example, if a patient changed doctors, then the new doctor may ask the previous doctor to send records, such as x-rays, etc., to the new doctor. This extra-plan card may be particularly useful in the event records must be assembled from multiple levels. For example, one request card may be sent to various departments within the prior doctor's hospital, until each department indicates that they've done their part. Users may then conveniently track progress by logging into the system and viewing the card to see who has completed their tasks and who has not yet done so.

It is noted that as discussed above, the physician may choose to make his plans and/or particular cards/blocks 80 available to a publically available library, e.g., by actuating publication module 56. A care provider may then subscribe to the library, e.g., of all orthopedic plans that have ever been created and then she may browse them and take a look at them and choose to purchase and download a plan from another physician. A shortcut to the public library may be provided on the system home page. Users may then browse plans based on substantially any one of various medical specialties, treatments, country, hospital, etc., e.g., by keyword.

It is also noted that cards may be edited either within the plan/block database 30 or within (i.e., after being assigned to) the patient's plan. When edited in the patient's plan, any changes will be made only in the particular patient plan, while any changes made to database/library cards will be reflected in any plans in which those cards are later used.

Having described operation of an exemplary embodiment from a care provider's point of view, this embodiment will now be described from a patient's point of view. Turning now to FIG. 13, a patient logging into the system sees a home page 90, which may include a greeting message/announcement 92 as shown. This message may be generated dynamically on a per-patient basis and displays respective announcements to be made “today”. The message may thus be a reminder of an upcoming activity specified in the patient's plan, such as a reminder to schedule an appointment with your physical therapist or that he has an appointment with the doctor in two days. The messages may be posted on top of the screen as shown, and appear when the user initially logs in to the system. The patient may then “OK” the announcement/s, and may then actuate any of an array of shortcuts (icons) 66″ to navigate within the system.

For example, the user may actuate the “view my plan” to view his plan as shown in the form of calendar 75 of FIG. 14. As discussed hereinabove, the user's plan has been generated by assembly module 26, by transforming the various building blocks (cards) 80 into entries associated with individual days on calendar 75. Exemplary entries, shown as 80′ in FIG. 14, may include exercises, medication, reminders, requests for feedback, and combinations thereof, etc.

In particular embodiments, the patient may see the day's date in relation to the surgery date or other anchor event, along with the activities that have been prescribed to this patient through the plan, such as to walk for 15 minutes and use a stationary bike. In addition, the user may be provided with a “more info” link, which may optionally be provided to bring the user to a Wiki page, or other external (or internal) web site that provides additional information, e.g., via a library linked to the system of the present invention.

In this regard, when going to the daily plan activity and then clicking on the more info button, the user may be brought to an underlying library of pictures, text instruction, videos, and/or whatever else has been provided and stored in this area. This screen also includes a display of any scheduled appointments for the day, along with any announcements that may have been displayed on the home page (FIG. 13). The patient may select the print button (icon) in order to print a copy of the day's plan events.

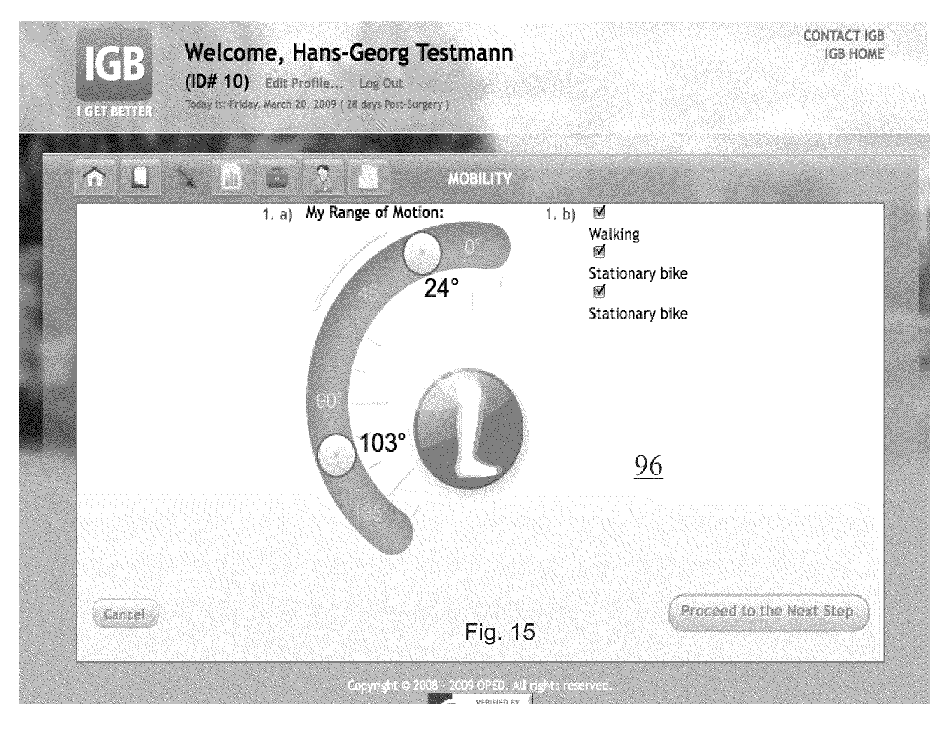

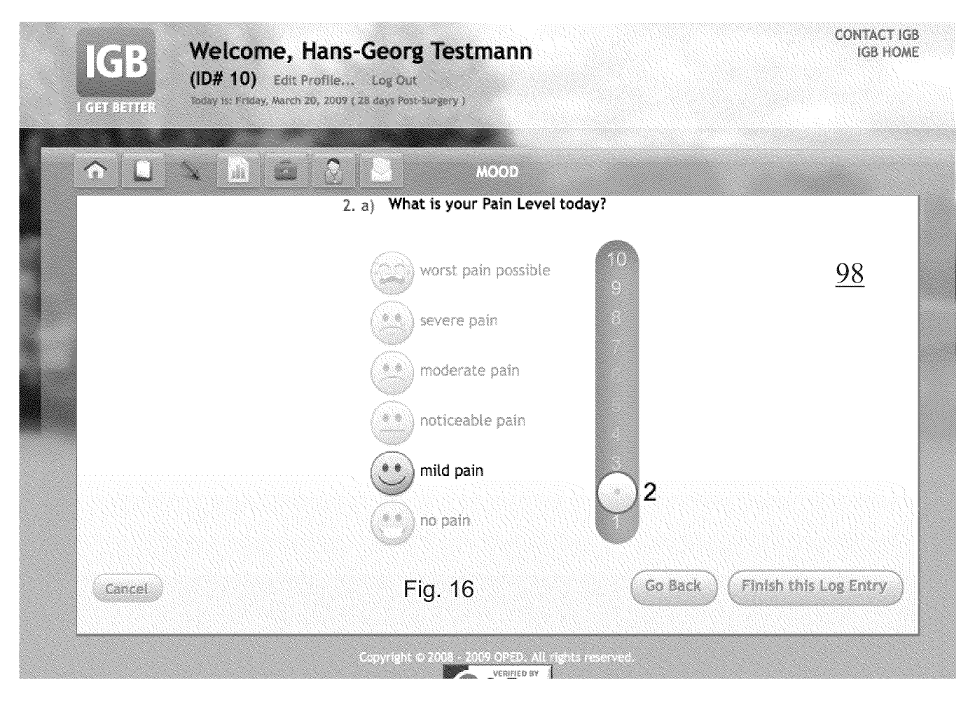

After completing the day's events, the patient may log in again and select the Log My Progress icon from the icon array 66′ (FIG. 13) to enter results into the plan. For example, as shown in FIG. 15, the user may respond to a mobility screen 96 requesting entry of range of motion of a knee. As shown, the patient may be asked to indicate how much he or she can extend an elbow or knee. The patient may also be asked whether they did any walking, riding of the stationary bike, etc. The system may then present the patient with any number of other screens, such as screen 98 of FIG. 16, in which the patient may enter his current pain level, and then click an icon to finish the log entry.

In this example, there is nothing more asked of this patient, but there may be any number of screens/cards asking for information from the patient, depending on the particular plan as set up by the health care provider(s), and as described hereinabove. For example, in the event the provider(s) were conducting a clinical trial, the requests of the patient may be relatively elaborate, requesting information on such things as what time did you get up in the morning, what did you eat today, what medications did you take, have you performed your exercises, what is your body weight in the morning at 7:00 a.m., what is your blood pressure if you have a device to measure it, etc.

Turning now to FIG. 17A, the patient is offered a progress report screen 76. In this view, various progress aspects predefined by the physician/plan may be shown. In this example, both the patient's range of motion and pain level over time are displayed graphically. As shown, one may see that the patient's motion in the knee ranges from zero to 135, with the range shown in degrees, while the green bars show at a glance how flexible this patient is. One may see that on some days, the patient's knee is relatively stiff, with an associated high level of pain, while on other days the opposite is true. Progress screen 77 of FIG. 17B shows whether the patient performed certain activities, while progress screen 77′ of FIG. 17C shows medication adherence.

As mentioned above, the information captured by the system may be used automatically, or manually by the physician, to make adjustments to the plan. For instance, in this example, overall decreases in pain level may be used to wean the patient off pain medication. For instance, the plan may be configured to recommend the patient be given pain medication as long as the pain level is at level 5 or above. As the pain level drops below 5 (e.g., without the patient taking medication), the plan may cut the pain medication in half, and so forth, to gradually wean the patient off the medication. In this manner, the plan eliminates the need for conventional pain prescriptions which typically instruct the patient to take a pain medication for a predetermined number of days, without any consideration for whether or not the patient still needs the medication. This aspect thus helps to avoid adverse affects associated with excess exposure to medication, while also potentially reducing the amount of money spent on prescription medicine.

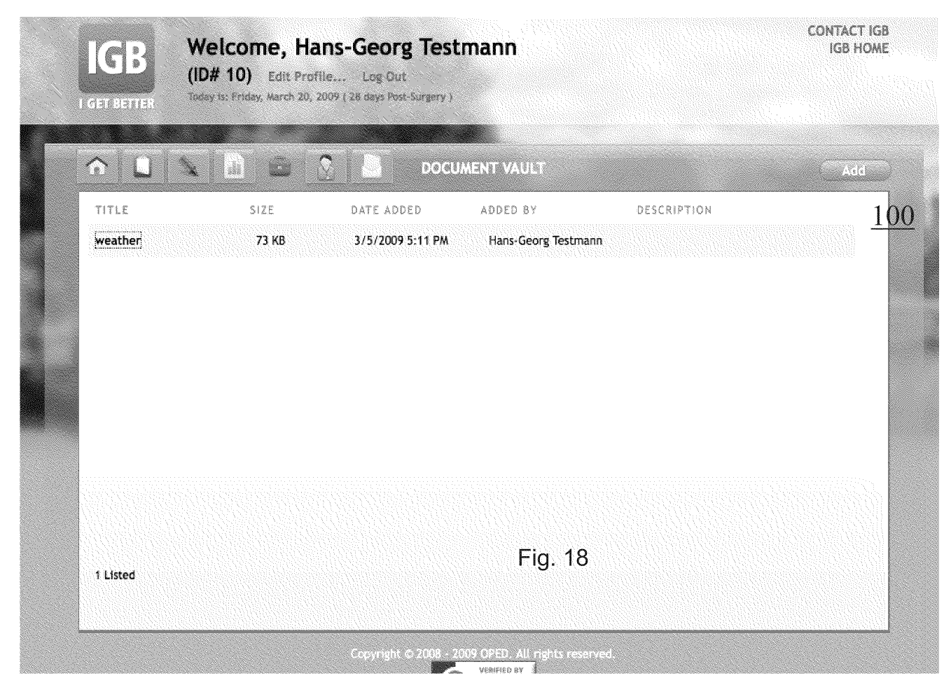

Turning now to FIG. 18, the patient may actuate the document vault icon from array 66″ (FIG. 13), to display the contents of his or her document vault at 100. This is substantially the same document vault discussed hereinabove with respect to the healthcare provider(s), and which is stored on servers 30 or 32 (FIG. 1A).

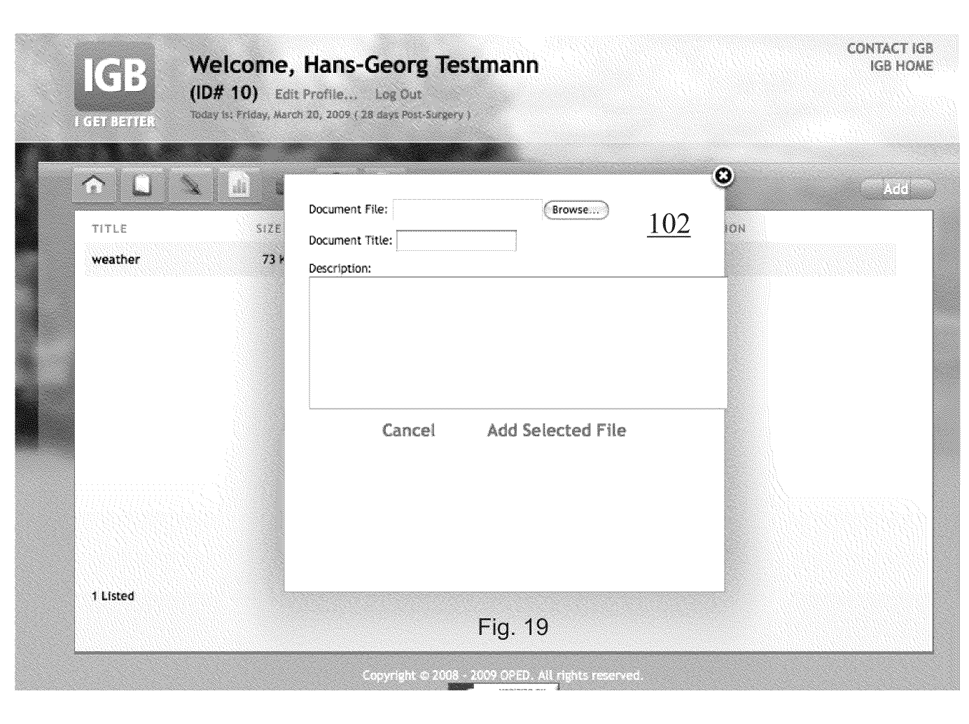

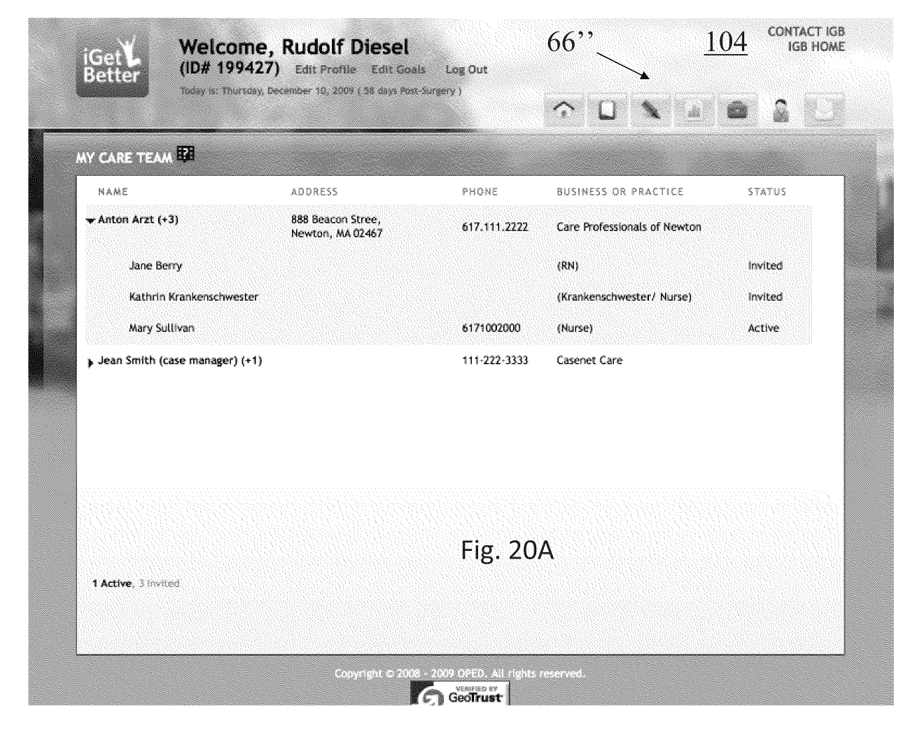

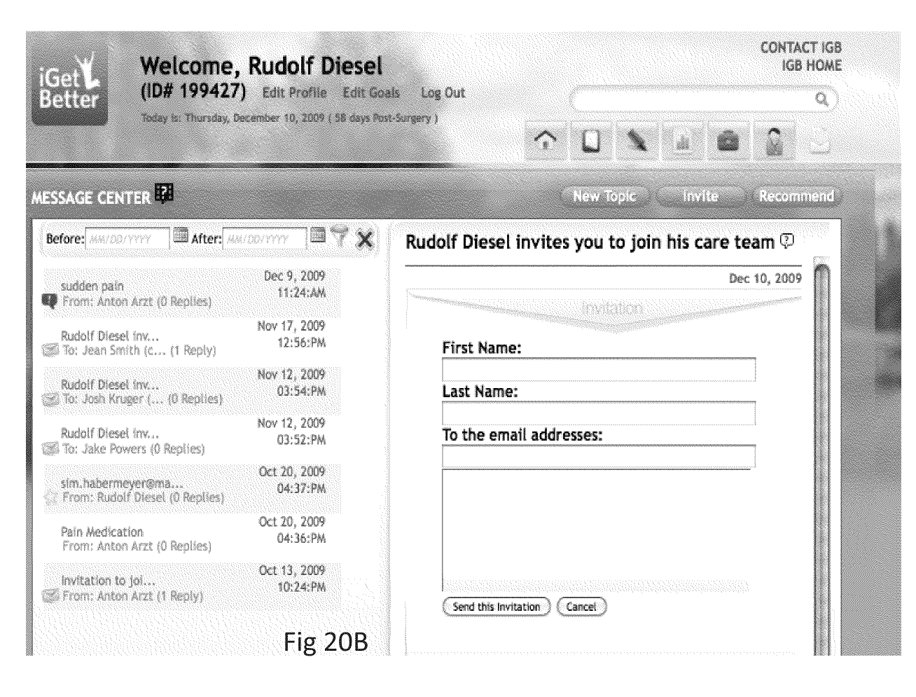

Referring now to FIG. 19, a patient may add another document to his file by selecting the Add button which opens a window 102 which permits the patient to browse his or her hard drive or other data storage devices (USB Memory, DVD, etc) to select a document or file. The document may then be added to the patient's document vault where it will be available to all members of his team of healthcare providers (according to the permissions assigned to the team members as discussed above). As shown in FIG. 20A, the patient may select the team member icon to view his team members via screen 104, including their titles/roles. As shown in FIG. 20B, the patient may invite new team members by selecting the Invite button and entering contact information into the designated fields. A field (not shown) may also be provided to set permissions for this new team member, i.e., to enable the patient to determine the level of access that this new team member will have to access the patient's records. There may also be a permission shortcut provided on the “My Care Team” page, which a patient may select to review and edit the permissions, assigned to the entire care team.

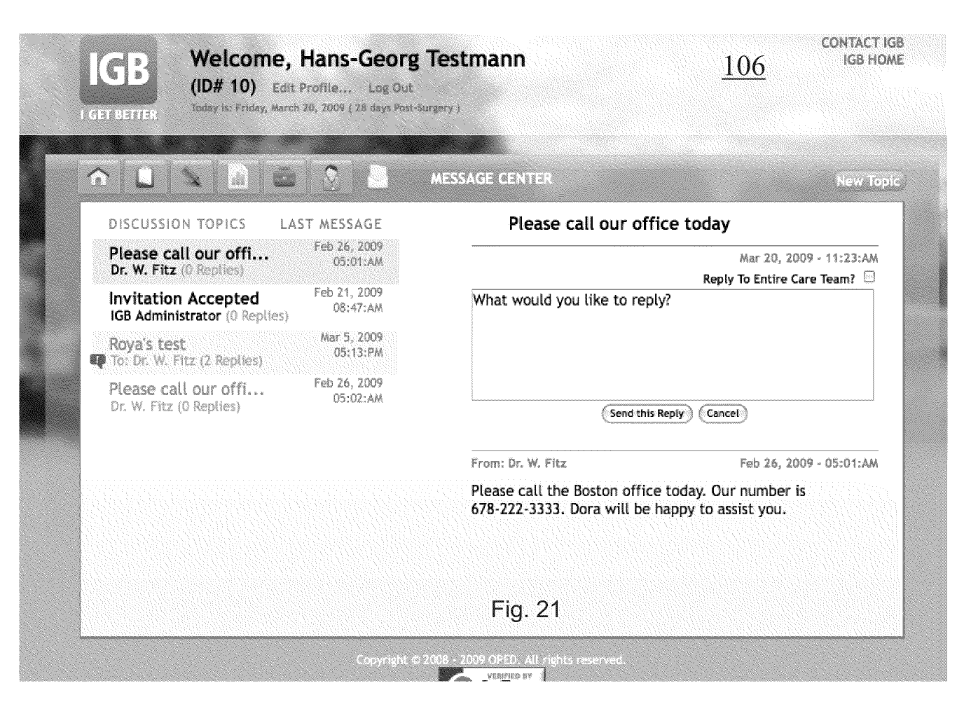

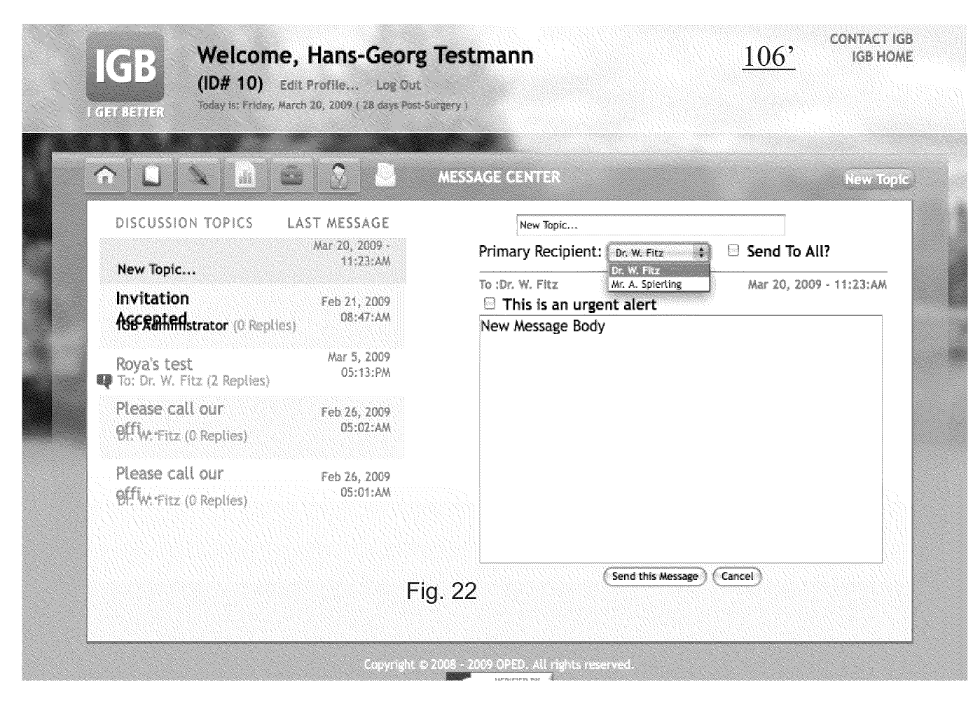

It should be noted that most, if not substantially all, of the screens that a user sees may be provided with array 66″ of shortcut icons, e.g., along the top of the screen, to facilitate navigation through the system without the need to first navigate to the Home page. For example, from the “My Care Team” page of FIG. 20, the patient may select the “Message Center” shortcut to view his messages as shown on screen 106 of FIG. 21. The patient's message center is substantially similar to those shown and described as 68 and 68′ of FIGS. 3, 4, with respect to a healthcare provider. Here, the patient may create draft messages, view and continue conversations relating to particular topics, select to whom messages should be sent, and whether the message should be sent as an alert or as a general message without specific urgency, e.g., as shown at screen 106′ of FIG. 22.

It is also noted that an aspect of the present invention is that it is patient-centric because substantially everything is tied to the patient (including a patient-tailored care plan), and that the patient may invite any doctor or other healthcare provider into her or his portfolio. Moreover, embodiments of the present invention are substantially borderless. For example, a patient may have a doctor in the United States, and another one in Germany where he may have had eye surgery. Embodiments of the present invention thus tie the team and documentation together, so that whoever accesses this patient will be able to see what's going on with the patient and create a plan. Regardless of where the plan originates, e.g., from a hospital in Germany or from one in Boston, everybody associated with the healthcare of this patient will be able to see what's going on, view communications and records applicable to their roles, etc. So this patient may move from one hospital to another hospital, from country to country, while all the relevant information stays in one place. Moreover, as discussed hereinabove, particular embodiments of the present invention may include a referral/appointment server 58 (FIG. 1A) configured to enable referrals and appointments to further streamline the work-flow and communication between the PCP (Primary Care Physician), specialist, etc., and patient, by providing a convenient means for arranging referrals and appointments.

As mentioned above, various embodiments of the present invention may be configured to transmit claims information to insurance companies. This aspect may advantageously eliminate a layer of complexity that exists today. Once a doctor and a patient are joined in the system, the patient information, the doctor information, and the applicable information regarding the patient's health, including medication and surgery, etc., are all in the system. Thus, the system may simply select the data relevant to a particular claim and then transmit it to the person's insurance company or other payer, in a paperless transaction. Again, this transaction may be substantially borderless. It should also be recognized that embodiments of these system may also automatically generate prescriptions and invoices to various payers for the various products and services discussed above, that a physician or other healthcare provider may insert into a patient's plan.

Embodiments of the present invention thus provide a dynamic, interactive, web-based medical treatment system in which a patient receives defined treatment information at an appropriate point in time, at substantially any location. Patients log their daily activities, and depending on progress or a lack thereof, the system may automatically accelerate or decelerate the care plan progression. These embodiments facilitate both standardization and customization of treatment plans to promote efficient care delivery.

In particular embodiments, the system includes a host (e.g., server) computer configured to generate modular, interactive cards that are the building blocks of treatment plans. These cards, in the form of program code modules each configured for selective interactivity with a user via a client computer or handheld computing device such as a PDA (personal digital assistant), cell phone, etc., while being interoperable with one another in substantially any combination, provide a convenient means for building a (e.g., episode-based) treatment regimen, for modifying the regimen for reuse, and for disseminating/marketing successful regimens or sub-regimens to others. Optionally, any one of these individual cards may be provided with the ability to dynamically alter (e.g. escalate/de-escalate) the overall treatment regimen to further enhance the system. Particular embodiments may provide a virtual store in which specific treatment regimens or sub-regimens in the form of individual cards or combinations thereof may be marketed to other professionals for download and further customization, e.g., to provide for efficient dissemination of best practices/outcomes throughout substantially the entire world.

It should be noted that the various modules and other components of the embodiments discussed hereinabove may be configured as hardware, as computer readable code stored in any suitable computer usable medium, such as ROM, RAM, flash memory, phase-change memory, magnetic disks, etc., and/or as combinations thereof, without departing from the scope of the present invention.

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer implemented interactive treatment system operable in a client-server environment, said system comprising:
a treatment system server having computer readable program code disposed therein, including computer readable program code configured to provide:
(a) a building block module configured to generate a plurality of modular, interactive building blocks for a treatment regimen;
the building blocks each representing a time-sensitive aspect of the treatment regimen;
the building blocks configured for being selectively assembled by a care provider client computer in substantially any combination, to form a customized treatment regimen;
the building blocks each configured to have a non-date specific temporal anchor point, the anchor points of the building blocks being linkable to one another upon said assembly of the building blocks to form a non-date specific common anchor point of the treatment regimen;
the building blocks configured for being selectable for interactivity at the care provider client computer so that the blocks selectively request and capture responsive patient input;
the building blocks being configured to selectively escalate and de-escalate the treatment regimen based on the captured patient input;
(b) an override module configured to permit the care provider client computer to selectively escalate, de-escalate, and modify the treatment regimen;
(c) an assembly module configured to transform the building blocks into entries on a calendar viewable on a patient client computer;
(d) a transformation module configured to transform the patient data input via a patient client computer into a graphical display of patient progress;
the treatment system server configured to permit selective access to the treatment program by care provider client computers and patient client computers;
a webserver communicably coupled to said treatment system server, configured to host a website configured to enable patient client computers and care provider client computers to access said treatment system server;
a treatment plan database server configured to store the assembled treatment plans;
a communications server communicably coupled to said webserver, said communications server configured to provide secure communications between the treatment system server and the care provider client computers, and between the treatment system server and the patient client computers;
said communications server configured to provide secure communication between the webserver and a patient record database.

2. A computer implemented interactive treatment system operable in a client-server environment, said system comprising:
a treatment system server having computer readable program code disposed therein, including computer readable program code configured to provide:
(a) a building block module configured to generate a plurality of modular, interactive building blocks for a treatment regimen;
the building blocks each representing a time-sensitive aspect of the treatment regimen;
the building blocks configured for being selectively assembled by a care provider client computer in substantially any combination, to form a customized treatment regimen;
(b) an assembly module configured to transform the building blocks into entries on a calendar viewable on a patient client computer;
(c) a transformation module configured to transform the patient data input via a patient client computer into a graphical display of patient progress;
the server configured for permitting selective access to the treatment program by care provider client computers and patient client computers;
a webserver communicably coupled to said treatment system server, configured to host a website configured to enable patient client computers and care provider client computers to access said treatment system server;
a treatment plan database server configured to store the assembled treatment plans;
a communications server communicably coupled to said webserver, said communications server configured to provide secure communications between care provider client computers and patient client computers;
said communications server configured to provide secure communication between the webserver and a patient record database.

3. The system of claim 2, wherein said building blocks are each configured to have a non-date specific temporal anchor point, the anchor points of the building blocks being linkable to one another upon said assembly of the building blocks to form a non-date specific common anchor point of the treatment regimen.

4. The system of claim 3, wherein said building blocks are configured for being selectable for interactivity at the care provider client computer so that the blocks selectively request and capture responsive patient input.

5. The system of claim 4, wherein said building blocks are configured to selectively escalate and de-escalate the treatment regimen based on the captured patient input.

6. The system of claim 2, further comprising an override module configured to permit the care provider client computer to selectively escalate, de-escalate, and modify the treatment regimen.

7. The system of claim 2, further comprising a patient record database server hosting the patient record database, communicably coupled to said webserver via the communications server.

8. The system of claim 2, wherein care provider client computer and the patient client computer comprise a web-enabled device.

9. The system of claim 8, wherein the web-enabled device is selected from the group consisting of cell phones, personal computers, personal digital assistants, netbooks, and combinations thereof.

10. The system of claim 3, wherein the building blocks are configured to permit the common anchor point of the treatment regimen to be mapped to a particular calendar date.

11. The system of claim 10, wherein the particular calendar date is selected from the group consisting of a surgery date, an injury date, a training commencement date, and combinations thereof.

12. The system of claim 2, wherein the time sensitive aspect of the building blocks includes at least one of periodic or one-time aspects of the treatment regimen.

13. The system of claim 2, wherein the building blocks are configured for being selectively assembled by dragging and dropping visual representations thereof.

14. The system of claim 2, wherein the assembly module is configured to transform the building blocks into entries on a calendar, wherein the entries include daily activities selected from the group of exercises, medication, reminders, requests for feedback, and combinations thereof.

15. The system of claim 2, wherein the transformation module is configured to transform the patient data into a graphical display of patient progress.

16. The system of claim 15, wherein the transformation module is configured to transform the patient data into a graphical display of patient progress substantially in real-time with the responsive patient input.

17. The system of claim 2, wherein the webserver further comprises a publication module configured to access said treatment database and to make at least modular portions of said assembled plans selectively available to a plurality of care provider client computers.

18. The system of claim 17, wherein the modular portions of said assembled plans are configured for reuse.

19. The system of claim 18, wherein the modular portions of said assembled plans are configured for interoperability with substantially any other modular portions of other assembled plans.

20. The system of claim 19, wherein the modular portions and the other modular portions are configured for being downloaded and further customized by care providers via care provider client computers.

21. The system of claim 2, further comprising a referral server having computer readable program code thereon, configured to communicate referrals via a referring care provider client to another care provider client, via the webserver.

22. The system of claim 21, wherein said referral server is configured to communicate appointments via care provider clients and patient client computers.

23. The system of claim 21, configured to transmit claims information to a payor client computer.

24. The system of claim 2, wherein the building blocks are configured for being interoperable with one another in substantially any combination.

25. The system of claim 2, wherein portions of the treatment regimen is configured for being saved for reuse.

26. The system of claim 2, comprising the care provider client computer.

27. A method of providing interactive patient treatment for a patient, said method comprising:
(a) accessing the system of claim 2, using a care provider client computer;
(b) creating, with the system, a customized treatment regimen for a patient, wherein the regimen is accessible by the patient; and
(c) monitoring, with the system, the patient's treatment progress.

28. The method of claim 27, further comprising storing at least modular portions of the treatment regimen.

29. The method of claim 28, comprising publicizing, with the system, the modular portions of the treatment plan.

30. The method of claim 29, wherein the publicizing comprises making the modular portions of the treatment plan available for download to others.
